(19) United States
(12) Patent Application Publication
(10) Pub. No.: US 2001/0015340 A1
(43) Pub. Date: Aug. 23, 2001

(54) Drinking vessel for infants

(76) Inventor: Gert F. Kolbel, Wedemark (DE)

Correspondence Address: COLLARD & ROE, P.C., 1077 Northern Boulevard, Roslyn, NY, 11576-1696, US

(21) Appl. No.: 09/770,071

(22) Filed: Jan. 25, 2001

(30) Foreign Application Priority Data
Jan. 26, 2000 (DE) 200 01 283.5

(51) Int. Cl. A61J 9/00

(52) U.S. Cl. 215/11.1; 215/395

(57) ABSTRACT

A drinking vessel for infants comprises a vessel wall made of an elastomer material, a nipple arranged on the wall, and a vessel bottom made of a rigid material and connected to the wall in a form-locked, yet detachable manner without any intermediate elements or adhesives. The vessel simulates the act of breast feeding and allows the liquid to flow into the infant's mouth without a vacuum building up up inside the vessel.

### BACKGROUND OF THE INVENTION

1. Field of the Invention

The invention relates to a drinking vessel for infants, having a vessel wall made of an elastomer material, a nipple arranged on the vessel wall, and a vessel bottom made of a rigid material.

2. The Prior Art

Drinking vessels for infants and small children are usually manufactured of glass or a non-elastic, rigid plastic material. Only the nipple sealing the neck of the baby bottle upwards is made of an elastomer material. While the infant is drinking, a vacuum develops as the level of the liquid drops in the vessel. Such a vacuum makes continuous sucking increasingly difficult and finally interrupts it. As the drinking process is interrupted, air flows through the suction opening into the interior of the baby bottle until pressure compensation is established. Drinking bottles with a pressure compensation valve have already been offered in the market in order to permit drinking without interruption. Such a valve is located on the nipple. The noise made by the inflow of the compensation air is nonetheless annoying, which, as opposed to drinking on the breast of the mother, constitutes an unnatural attendant phenomenon. Therefore, drinking from a rigid glass- or plastic-made bottle is overall an unnatural act.

Another alternative is shown by U.S. Pat. No. 5,690,679, which comprises a vessel made of an elastic material and with an essentially semispherical shape to provide the infant with the feeling of drinking on the mother's breast. On its filling and terminating side, the drinking vessel is glued together with a rigid inner ring representing an intermediate element with a female thread. The inner ring extends all around, in order to permit a sealing plate to be secured there. The manufacture of such a drinking vessel requires substantial expenditure and is cost-intensive. The use of adhesive material raises special concerns for health reasons, especially in the area where infants are involved.

Older children and small children, who are already independent to some extent, are not able to hold the drinking vessel with their small hands. The alternative shifting of the filling opening into the zone of the suction nipple, which is shown in this publication, leads to a hard screw zone, which is to be avoided.

### SUMMARY OF THE INVENTION

It is an object of the invention to avoid the drawbacks specified above and to provide a drinking vessel for infants made of a soft elastomer material without troublesome hard or rigid zones, and which, with the simplest of technical means, permits the child to drink without any troublesome vacuum developing as the child is drinking, so that the drinking process conforms to the act of breast-feeding a child. The drinking vessel is to be completely free of glued or vulcanized spots.

This object is accomplished by the invention in that the bottom is directly joined in a form-locked, yet detachable manner with the elastomer wall of the vessel, with exclusion of any intermediate elements. The sealable opening required for filling and emptying the drinking vessel is preferably arranged in the bottom of the vessel.

The bottom of the vessel is preferably formed by two coaxial plates. These plates abut each other and are screwed to one other. The inner one of the two plates facing the interior of the vessel has a central filling opening bordered by a screw edge with a female thread. This filling opening is engaged by a screw attachment on the outer plate. The screw attachment has a male thread for hermetic sealing.

The inner bottom plate is preferably provided with a groove extending over its entire outer circumference. This groove is engaged by the elastomer wall of the vessel by means of a ring-shaped thickening or holding bead.

Although the holding bead is capable of engaging the peripheral groove of the outer bottom plate with initial tension, it is advantageous if the outer bottom plate has an edge that grips over the holding bead in the form of a pot and additionally secures the holding bead against sliding out of the groove. This way, the bead is reliably prevented from sliding out of the peripheral groove of the inner bottom plate, taking into account the weight of the filled amount of liquid as well. To simplify handling of the vessel, a holding bow such as an elastic clip can be attached to the outer bottom plate, and can be pressed with initial tension over the outer bottom plate.

In order for slightly older children to hold the drinking vessel on their own, the holding bow can have handles at both ends that extend downwards in the direction toward the mouth. The wall of the vessel preferably has an approximately semi-spherical shape.

The wall of the vessel, particularly if the vessel has a semi-spherical shape or the form of a breast, can be easily and completely sucked out by the infant without air flowing into the vessel intermittently as an annoying process, because the semi-spherical shape can readily assume a rotation-symmetrical form in the course of the drinking process. While drinking from the vessel, it can be pulled increasingly closer to the drinking child. No air vacuum develops and no annoying noise is caused by an inflow of air. The drinking process therefore conforms to nature's preset rules. A pressure compensation valve can be entirely dispensed with.

In order to increase the holding capacity of the drinking vessel beyond the volume of the elastomer container, the outer bottom plate has a standardized screw opening that is coaxial with the inner bottom plate, so that it is possible to additionally screw a conventional drinking bottle made of glass or plastic material into the screw opening. When such a requirement is lacking, the opening can be sealed liquid-tight by a simple threaded stopper.

### BRIEF DESCRIPTION OF THE DRAWINGS

Other objects and features of the present invention will become apparent from the following detailed description considered in connection with the accompanying drawings which discloses two embodiments of the invention. It should be understood, however, that the drawings are designed for the purpose of illustration only and not as a definition of the limits of the invention.

In the drawings, wherein similar reference characters denote similar elements throughout the several views:

FIG. 1 shows a drinking vessel in a partial longitudinal section; and

FIG. 2 shows the drinking vessel according to FIG. 1 with an additional screw opening.

### DETAILED DESCRIPTION OF THE PREFERRED EMBODIMENTS

The drinking vessel consists of a two-component bottom 1 with a vessel wall 2 made of an elastomer material, and with a dummy teat or sucking mouthpiece 3 adjoining wall 2 and forming one single component jointly with wall 2. The vessel bottom 1 is composed of an outer bottom plate 4 and an inner bottom plate 5 facing the interior of the vessel.

Inner bottom plate 5 has a central filling opening 8 defined by a screw edge 6 with a female thread 7. Along its outer circumference, inner bottom plate 5 has a receiving groove 9 spanning its entire circumference, which receives a ring-shaped holding bead 10 of wall 2 of the vessel.

For closing and hermetically sealing the opening 8, outer bottom plate 4 is equipped with a screw attachment 11 with a male thread, the dimensions of the male thread being adapted to female thread 7 of inner bottom plate 5.

In order to prevent the ring shaped holding bead 10 from slipping out of its receiving groove even when the drinking vessel is filled with a drinkable liquid, outer bottom plate 4 is provided with an edge 12 extending all around. Edge 12 extends over groove 9, as well as over the inserted holding bead 10, and prevents bead 10 from slipping out as a result of the form-locked safety feature so created.

A holding bow 13 in the form of an elastic clip or clamping spring is provided in order to facilitate the handling of the vessel. With its ends 14 and its components 14a adjoining ends 14 at right angles, elastic clip 13 extends over edge 12 of outer bottom plate 4 and forms a safe clamping means. In addition, holding bow 13 can be equipped on its outer ends with handles 15 for permitting the infant himself or herself to hold the vessel while drinking from it. Holding bow 13 with handles 15 can also be designed so that it forms one single piece with bottom plate 4.

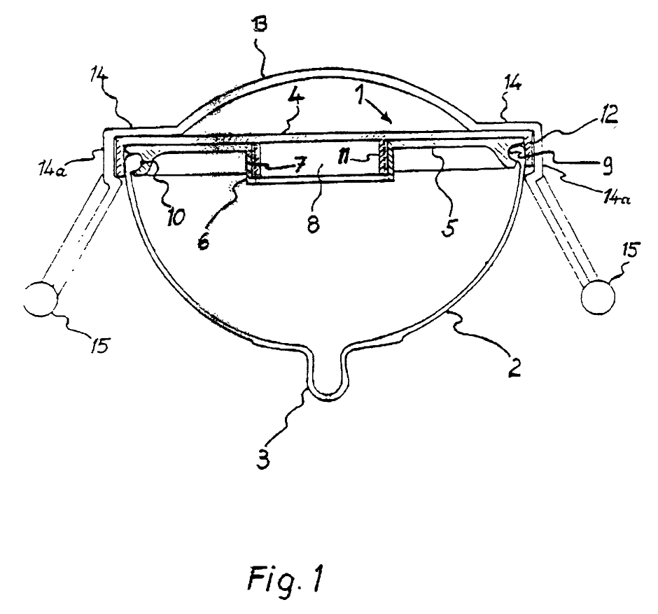

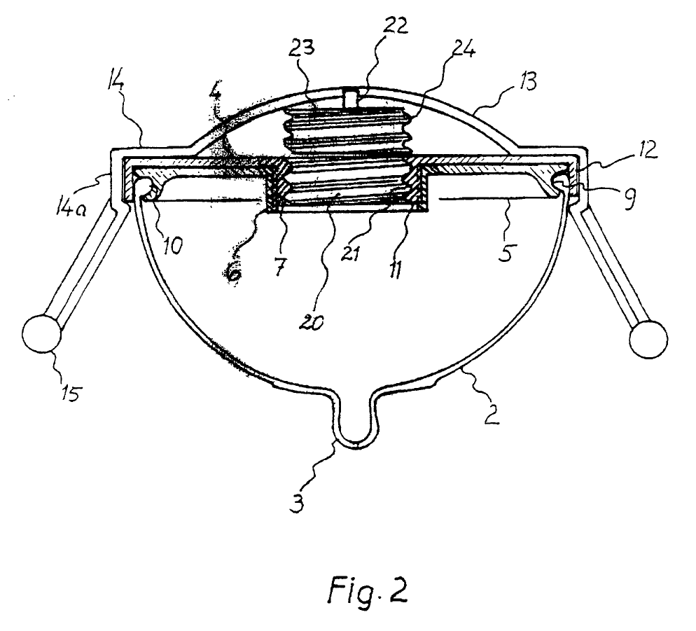

The embodiment of the drinking vessel according to FIG. 2 differs from the one according to FIG. 1 in that it has an opening 20 with a standardized screw thread 21 located in outer bottom plate 4. A stopper 23 with male thread 24 and actuating attachment 22 seals opening 20. When required, stopper 23 can be screwed out and replaced by a standard drinking bottle (not shown) with a screw attachment in order to enlarge the total volume.

To keep it warm, the drinking vessel can be placed in a water bath with the flatly constructed bow handle pointing down, so that the entire body of the drinking vessel is covered by warm water except for the suction nipple extending beyond the water level. In this way, the water can circulate under the bottom plate because it is kept spaced from the bottom of the warm water container by the bow.

Accordingly, while a few embodiments of the present invention have been shown and described, it is to be understood that many changes and modifications may be made thereunto without departing from the spirit and scope of the invention as defined in the appended claims.

What is claimed is:

1. A drinking vessel for infants, comprising:
a vessel wall made of an elastomer material;
a nipple arranged on said wall; and
a vessel bottom made of a rigid material, and connected to said wall in a form-locked, yet detachable manner without any intermediate elements.

2. The drinking vessel according to claim 1, further comprising a sealable filling opening arranged on said bottom.

3. The drinking vessel according to claim 1, wherein the bottom comprises two coaxial plates screwed to each other, with an inner one of said plates facing the interior of the vessel and having a central filling opening defined by a screw edge with a female thread, and wherein an outer one of said plates has a screw attachment with a male thread, for engaging the filling opening and hermetically sealing the vessel.

4. The drinking vessel according to claim 3, wherein the inner bottom plate is provided with a groove extending over its entire outer circumference, said groove engaging the elastomer wall of the vessel via a holding bead on the elastomer wall.

5. The drinking vessel according to claim 4, wherein an edge of the outer bottom plate extends over the holding bead in the form of a pot, thereby securing said bead against slipping out of the groove.

6. The drinking vessel according to claim 5, wherein the holding bead engages the groove of the inner bottom plate with initial tension.

7. The drinking vessel according to claim 1, wherein the elastomer wall of the vessel and the nipple are formed from one single part.

8. The drinking vessel according to claim 3, wherein the outer bottom plate is provided with a detachable holding bow.

9. The drinking vessel according to claim 8, wherein the holding bow comprises an elastic clip or clamping element having ends adapted to be pushed with initial tension over the outer bottom plate.

10. The drinking vessel according to claim 8, further comprising handles attached to both ends of the holding bow.

11. The drinking vessel according to claim 1, wherein the wall of the vessel is in the form of a semisphere.

12. The drinking vessel according to claim 3, wherein the outer bottom plate is provided with a screw opening disposed coaxial with the filling opening of the inner bottom plate for screwing in glass or plastic bottles.
